(19) United States
(12) Patent Application Publication
(10) Pub. No.: US 2009/0172784 A1
(43) Pub. Date: Jul. 2, 2009

(54) Apparatus and method for processing data broadcast signal

(75) Inventors: Ji Ho Park, Seoul (KR); Hak Joo Lee, Seoul (KR)

Correspondence Address: MCKENNA LONG & ALDRIDGE LLP, 1900 K STREET, NW, WASHINGTON, DC, 20006, US

(73) Assignee: LG. Electronics, Inc., Seoul (KR)

(21) Appl. No.: 12/005,669

(22) Filed: Dec. 28, 2007

(51) Int. Cl. H04L 9/32

(52) U.S. Cl. 726/4

(57) ABSTRACT

An apparatus and method for receiving and processing a data broadcast signal is disclosed. The apparatus receives a data broadcast signal including the application information table and the application, and authenticates the received application. The apparatus can execute a corresponding application only when the execution of the application is permitted according to the authentication result.

### BACKGROUND OF THE INVENTION

1. Field of the Invention

The present invention relates to an apparatus and method for processing a data broadcast signal associated with authentication of the data broadcasting application.

2. Discussion of the Related Art

Recently, with the rapidly increasing development of digital broadcasting technology, a broadcast station transmits not only video and audio broadcast signals but also various data broadcast signals, or transmits the video and audio broadcast signals separately from the data broadcast signals.

There are a variety of data broadcast application platforms, i.e., a Open Cable Application Platform (OCAP), a Multimedia Home Platform (MHP), and an Advanced Common Application Platform (ACAP), etc.

For example, the OCAP is an application platform for North American cable data broadcasting, the MHP is an application for European data broadcasting, and the ACAP is an application platform for North American terrestrial data broadcasting.

The above-mentioned platforms are based on the Application Information Table (AIT). The AIT is a table for describing the data broadcast application and its associated information.

Presently, most of the data broadcast applications have been attached to A/V information. In other words, the data broadcast applications are providing desired users with information more detailed than the A/V information. Other games are employing functions different from the A/V information, instead of the above-mentioned simple assessment information.

The reason why the above-mentioned data broadcast application has been widely used is a lack of the market quality in the data broadcast application. In other words, the data broadcast application has a sufficient amount of information capable of being acquired from the conventional A/V signal, and is used as a supplementary function of the conventional A/V signal.

However, provided that the sufficient amount of information can be transmitted to a destination via the data broadcast application, the high-class data broadcast application is required. For example, information better than that of the A/V signal can be transmitted to the user via the data broadcast application.

In order to provide the high-class data broadcast application, the fee for the data broadcast application must be charged.

### SUMMARY OF THE INVENTION

Accordingly, the present invention is directed to an apparatus and method for processing a data broadcast signal that substantially obviate one or more problems due to limitations and disadvantages of the related art.

An object of the present invention is to provide an apparatus and method for performing an account associated with the data broadcast application by an authentication process.

Additional advantages, objects, and features of the invention will be set forth in part in the description which follow and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for receiving and processing a data broadcast signal may include receiving a data broadcast signal including an application information table and an application, authenticating the application, and executing the application only when an execution is permitted according to the authentication result.

Preferably, the authenticating step include detecting authentication indication information including location information of an authentication server from the application information table, if the authentication indication information is detected, generating an authentication request message of a corresponding application, and transmitting the authentication request message to the authentication server, and receiving an authentication response message associated with the authentication-requested application from the authentication server.

Preferably, the authentication indication information is contained in at least one of common and application loops contained in the application information table.

Preferably, the authentication request message includes first identification information for identifying a receiver generating an authentication request, and second identification information for identifying an application generating an authentication request.

Preferably, the authentication response message includes at least one of specific information indicating whether the execution is permitted, and runtime information limiting a runtime of a corresponding application.

In another aspect of the present invention, there is provided an apparatus for receiving and processing a data broadcast signal may include a receiving part, a decoder, and an application controller. The receiver receives a data broadcast signal including an application information table and an application. The decoder decodes the received application and the received application information table. The application controller controls authentication of the application according to information contained in the decoded application information table, and controlling execution of the application according to the authentication result.

Preferably, the application controller, if authentication indication information including location information of an authentication server is detected from the application information table, generates an authentication request message of a corresponding application, transmits the authentication request message to the authentication server, and receives an authentication response message associated with the authentication-requested application from the authentication server.

Preferably, the authentication request message includes first identification information for identifying a receiver generating an authentication request; and second identification information for identifying an application generating an authentication request.

Preferably, the authentication response message includes at least one of specific information indicating whether the execution is permitted, and runtime information for limiting a runtime of a corresponding application.

As a result, the present invention provides the data broadcast application with an authentication system, so that it can provide users with the high-class data broadcast services. The present invention can authenticate the individual applications independent of each other, so that the authentication process can be more effectively conducted, resulting in the occurrence of detailed authentication processes.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a flow chart illustrating a data broadcast application according to the present invention;

FIG. 2 is a block diagram illustrating an authentication server of an application according to the present invention;

FIG. 3 is a structural diagram illustrating a charging descriptor syntax according to the present invention;

FIG. 4 is a structural diagram illustrating a syntax structure of an application information table in which a charging descriptor will be contained according to the present invention;

FIG. 5 is a structural diagram illustrating an authentication request message according to one embodiment of the present invention;

FIG. 6 is a structural diagram illustrating an authentication response message according to one embodiment of the present invention;

FIG. 7 is a flow chart illustrating a method for processing a data broadcast application based on an authentication response message of FIG. 6 according to the present invention;

FIG. 8 is a structural diagram illustrating an authentication response message according to another embodiment of the present invention;

FIG. 9 is a flow chart illustrating a method for processing a data broadcast application based on an authentication response message of FIG. 8 according to the present invention; and

FIG. 10 is a block diagram illustrating an apparatus for receiving a data broadcast signal according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Prior to describing the present invention, it should be noted that most terms disclosed in the present invention correspond to general terms well known in the art, but some terms have been selected by the applicant as necessary and will hereinafter be disclosed in the following description of the present invention. Therefore, it is preferable that the terms defined by the applicant be understood on the basis of their meanings in the present invention.

For the convenience of description and better understanding of the present invention, general structures and devices well known in the art will be omitted or be denoted by a block diagram or a flow chart. Wherever possible, the same reference numbers will be used throughout the drawings to refer to the same or like parts.

Prior to describing the present invention, upon receiving the data broadcast application, the present invention authenticates the received data broadcast application, and aims to execute the corresponding data broadcast application only when an execution of the data broadcast application is allowed.

In this case, the present invention may authenticate all the data broadcast applications, or may authenticate only a specific data broadcast application capable of satisfying predetermined conditions.

The present invention may authenticate the data broadcast application indicating the authentication.

For this purpose, a transmission end of the present invention includes authentication indication information in the application information table (AIT) of the data broadcast application required for the authentication.

A reception end of the present invention detects authentication indication information from the received application information table, and is designed to authenticate only the data broadcast application corresponding to the detected authentication indication information.

The authentication indication information includes authentication sever information performing the actual authentication.

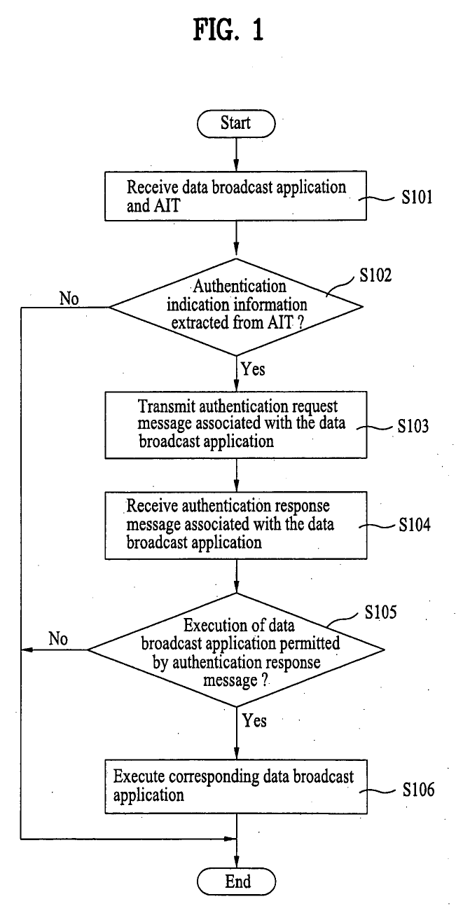

FIG. 1 is a flow chart illustrating a data broadcast application according to the present invention.

Specifically, FIG. 1 shows a data broadcast processing method for use in a broadcast receiver.

Referring to FIG. 1, a broadcast receiver receives the data broadcast application and the application information table (AIT) from the transmission end such as a broadcast station at step S101.

The broadcast receiver detects the authentication indication information from the received AIT at step S102. The authentication indication information includes authentication server information required for the authentication.

For example, the authentication server information may be address information at which the authentication server is located. The authentication indication information may be detected when the application information table (AIT) is received, or may be detected when an execution request of a specific data broadcast application is received.

If the authentication indication information is not detected at step S102, a corresponding data broadcast application is immediately executed without performing the authentication process at step S106.

In the meantime, if the authentication indication information is detected at step S102, an authentication request message of the corresponding data broadcast application is created, and this authentication request message is transmitted to the authentication server contained in the authentication indication information at step S103.

In this case, the authentication server performs authentication of the corresponding data broadcast application upon receiving the authentication request message, includes the authentication result in the authentication response message, and transmits the authentication response message including the authentication result to the corresponding broadcast receiver.

The authentication response message may include first information indicating whether the execution is allowed or not, or may include second information indicating runtime information. Otherwise, the authentication response message may also include the first information and the second information.

Therefore, the broadcast receiver receives the authentication response message from the authentication server at step S104, and determines whether the authentication response message permits the execution of the corresponding data broadcast application at step S105.

If the permission of the data broadcast application execution is confirmed at step S105, the broadcast receiver executes the corresponding data broadcast application at step S106.

For example, if only the execution permission information is contained in the above-mentioned authentication response message, the broadcast receiver executes the corresponding data broadcast application irrespective of time. For another example, if the runtime information is contained in the authentication response message, the broadcast receiver may execute the corresponding data broadcast application only during a specific time corresponding to the runtime information.

In the meantime, if the execution is not permitted or the data broadcast application is not matched with the permission condition, the broadcast receiver may stop operations of the corresponding data broadcast application without executing the same, or may re-transmit the data broadcast application authentication request.

The authentication indication information contained in the application information table (AIT), the authentication request message requested by the broadcast receiver, and the authentication response message received from the authentication server will hereinafter be described with reference to the annexed drawings.

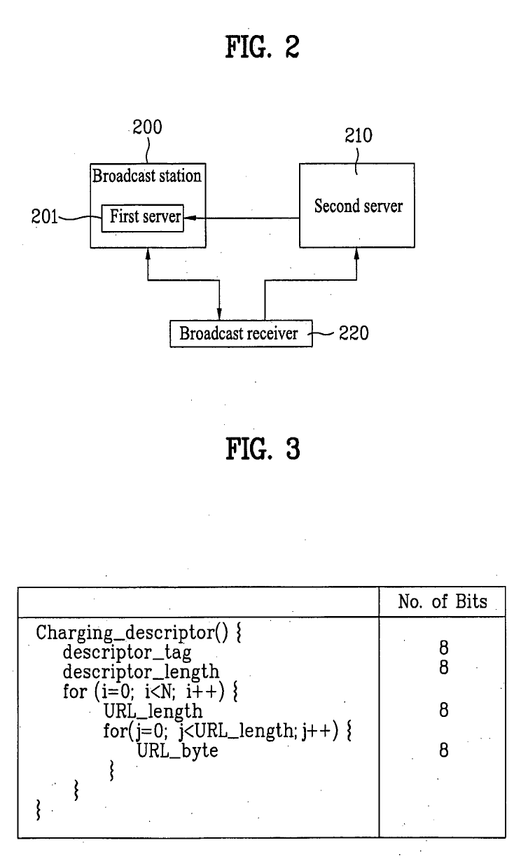

FIG. 2 is a block diagram illustrating an authentication server of an application according to the present invention.

The present invention is designed to authenticate whether the data broadcast application is executed in the broadcast receiver or not. For this purpose, the present invention includes an authentication server. Upon receiving the authentication request from the broadcast receiver, the authentication server performs authentication of the corresponding data broadcast application, and transmits a response to the authentication request to the corresponding broadcast receiver.

The authentication server may be a first authentication server 201, or may be a second authentication server 210 separated from a broadcast station. For example, the second authentication server 210 may be a manufacturing company of the application. The entity for managing the number of authentication servers and operations of the authentication server may be easily changed to another entity by those skilled in the art, so that the scope of the present invention is not limited to this example and can also be applied to other examples.

The present invention describes the authentication indication information including the authentication server information in the application information table (AIT), and transmits the application information table (AIT).

There are a variety of methods for describing the authentication indication information in the application information table (AIT).

For the convenience of description and better understanding of the present invention, one embodiment of the present invention defines an authentication descriptor in the application information table (AIT), describes the authentication server information in this descriptor, and transmits the resultant descriptor. It should be noted that this embodiment is disclosed only for illustrative purposes, and the method for describing/transmitting the authentication server information in the application information table can be applied to many more examples, so that the scope of the present invention is not limited to the above-mentioned embodiment and can also be applied to other examples.

For the convenience of description, the present invention sets a descriptor for describing the authentication server information to a charging descriptor.

In other words, the charging descriptor corresponds to the authentication indication information, and the authentication server information is described in the charging descriptor.

If the charging descriptor is contained in the application information table (AIT), the present invention performs the authentication process of the corresponding data broadcast application, and executes the corresponding data broadcast application according to the authentication result. Otherwise, if the charging descriptor is not contained in the application information table (AIT), the present invention executes the corresponding data broadcast application without performing the authentication process.

The authentication server information described in the charging descriptor includes address information at which the authentication server is located.

In other words, the authentication server may be connected to the broadcast receiver via a wired or wireless network. In this case, the broadcast receiver transmits an authentication request, and must recognize location information of the authentication server so as to receive a response to the authentication request.

If the authentication server is connected to the broadcast receiver over the Internet network, the location information of the authentication server may be a Uniform Resource Locator (URL).

There are a variety of bidirectional communication methods between the broadcast receiver and the authentication server, for example, an optical carrier (OC), an Internet Protocol (IP), and an Interaction Channel Protocol (ICP), etc., so that an authentication request message and an authentication response message can be communicated between the broadcast receiver and the authentication server using any one of the above-mentioned bidirectional communication methods. The above-mentioned examples of the bidirectional communication have been disclosed only for illustrative purposes, and the scope of the present invention is not limited to the above-mentioned examples and can also be applied to other examples.

FIG. 3 is a structural diagram illustrating a charging descriptor (charging_descriptor) syntax according to the present invention.

The charging descriptor of FIG. 3 may include a descriptor tag field, a descriptor length field, and a URL field.

In one embodiment, 8 bits are allocated to the descriptor tag field, and a unique identification (ID) value capable of identifying that this descriptor is a charging descriptor is allocated to the descriptor tag field.

In one embodiment, 8 bits are allocated to the descriptor length field, so that the descriptor length field indicates a total length of the charging descriptor.

In one embodiment, 8 bits are allocated to the URL field, and this URL field is repeated as long as a URL length.

In other words, the charging descriptor may indicate the address of a server which authenticates the execution of the data broadcast application using the URL. There are a variety of URL formats, for example, a DAB URL, a DMB URL, an Internet URL, and an ATSC URL, etc. It should be noted that different address indication methods are allocated to the individual URL formats.

The charging descriptor is contained in the application information table (AIT), and is transmitted as a data signal to a destination.

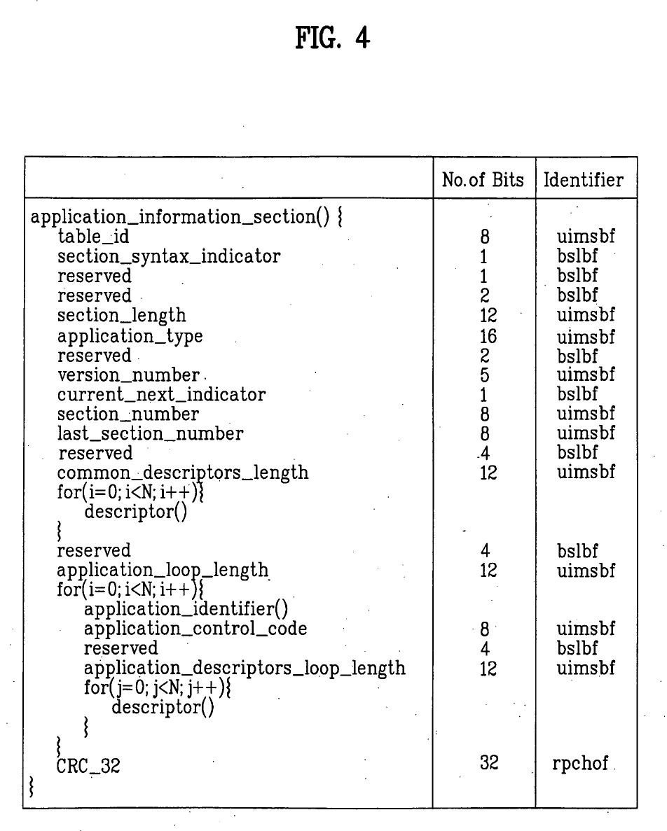

FIG. 4 is a structural diagram illustrating a syntax structure of an application information table in which a charging descriptor will be contained according to the present invention.

Referring to FIG. 4, the “table_id” field describes a unique table ID allocated to the AIT.

The “application_type” field describes the type of the data broadcast application described in the corresponding application information table (AIT). For example, the “application_type” field may indicate whether a corresponding application is equal to the DVB-J application or the DVB-HTML application.

The “common_descriptor_length” field indicates a total length of the descriptors contained in the common loop in the form of bytes.

The “application_loop_length” field indicates a total length of the application loop in the form of bytes.

The “application_identifiero” field describes a unique ID of the corresponding data broadcast application contained in the application loop.

The “application_control_code” field indicates the status of the corresponding data broadcast application.

The “application_descriptor_loop_length” field indicates a total length of descriptors in the form of bytes.

The charging descriptor according to the present invention may be contained in the common loop in the application information table (AIT), or may also be contained in the application loop in the application information table (AIT) shown in FIG. 4.

Referring to the application information table (AIT) of FIG. 4, the “descriptors( )” information may be inserted into only two places. One of the two places is in the common loop, and the other one is in the application loop.

The descriptors contained in the common loop are located behind the “common_descriptors_length” field. Other descriptors contained in the application loop are located behind the “application_descriptors_loop_length” field.

The descriptors contained in the common loop are commonly applied to all the data broadcast applications described in the application information table (AIT). However, the other descriptors contained in the application loop are separately applied to each of the data broadcast applications.

In other words, a single application information table (AIT) may include information of several data broadcast applications. In this case, the common explanation of the several data broadcast applications is defined in the common loop, and the explanation of each of the data broadcast applications is defined in the application loop.

For example, provided that there is an application information table (A) including information of the data broadcast applications 1, 2, and 3, and there is an authentication server for authenticating the execution of the data broadcast applications 1, 2, and 3, the charging descriptor may be contained in the common loop of the application information table (A). In this case, the charging descriptor may be contained in the application loop as necessary.

However, if at least one of the data broadcast applications 1, 2, and 3 is authenticated in another authentication server, the charging descriptor is contained in the application loop.

In another embodiment, the present invention may transmit the authentication server information using a reserved field contained in the application information table (AIT). No function is allocated to the reserved field for future use, so that an empty space is allocated to the reserved field for the future use.

If the authentication server information is described in the reserved field contained in the common loop, this authentication server information is commonly applied to all the data broadcast applications described in the application information table (AIT). Otherwise, if the authentication server information is described in the reserved field contained in the application loop, this authentication server information is separately applied to each data broadcast application.

Provided that the broadcast receiver according to the present invention receives the data broadcast application and the application information table (AIT), and detects the charging descriptor from the application information table (AIT), the broadcast receiver performs parsing of the charging descriptor and acquires the authentication server information.

The detection of the charging descriptor may be conducted by a descriptor tag value allocated to the charging descriptor itself. If the charging descriptor is detected, the authentication request message is created, and is then transmitted to the authentication server acquired by the parsing of the charging descriptor.

The authentication request message requests the execution authentication of the data broadcast application of a specific broadcast receiver. The authentication request message includes not only unique information of the broadcast receiver of requesting the authentication but also the other unique information of the data broadcast application associated with the actual authentication.

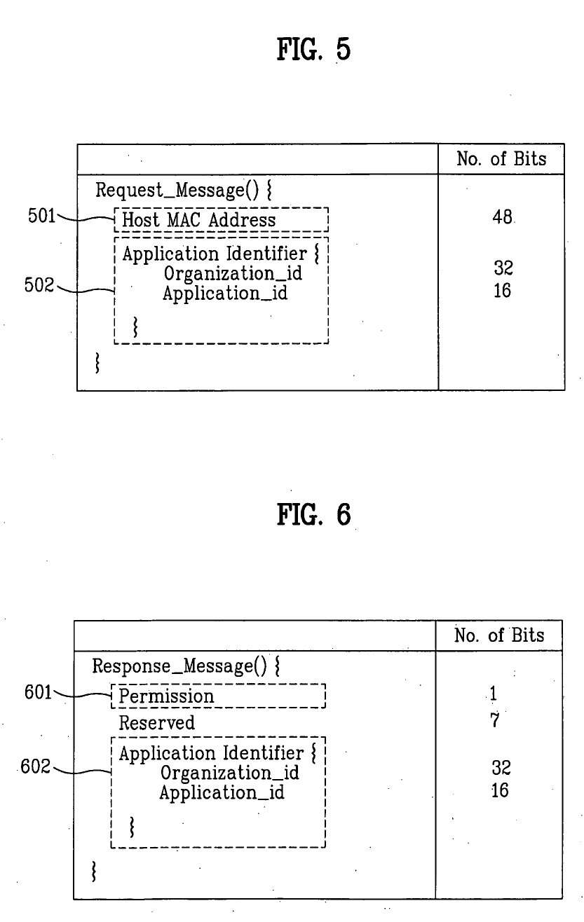

FIG. 5 is a structural diagram illustrating an authentication request message “Request_Message( )” according to one embodiment of the present invention.

Referring to FIG. 5, the authentication request message “Request_Message( )” includes a receiver identifier (ID) field 501 and application identifier (ID) field 502.

48 bits are allocated to the receiver identifier field 501, and the receiver identifier field 501 includes ID information of the broadcast receiver which transmits an authentication request. The ID information of the broadcast receiver may be set to a host MAC address or a host's serial number. As can be seen from FIG. 5, the host MAC address is used as the ID information of the broadcast receiver.

The application ID field 502 includes the “organization_id” field of 32 bits and the “application_id” field of 16 bits, and describes an unique identifier capable of identifying the data broadcast application by which the actual authentication will be conducted.

The “organization_id” field may indicate a specific value for identifying a unit which may manufacture or transmit the corresponding data broadcast application. For example, the “organization_id” field may be set to a broadcast station such as “NBC”.

The “application_id” field may indicate a specific value capable of identifying only the data broadcast application.

The authentication server for receiving the authentication request message may permit or reject the execution of the corresponding data broadcast application according to the broadcast receiver's charging status contained in the authentication request message. After generating the authentication response message including the authentication result, the authentication server transmits the authentication response message to the corresponding broadcast receiver.

If it is determined that the broadcast receiver's charging status contained in the authentication request message is normal, the authentication server generates an authentication response message for the execution permission, and transmits the authentication response message to the corresponding broadcast receiver.

In this case, the authentication response message indicating the authentication result may include first information indicating whether the execution is permitted, or may include second information indicating the runtime. For another example, the authentication response message may include the first information and the second information. In this case, the runtime may be differently decided according to the charging status or grade of the corresponding broadcast receiver.

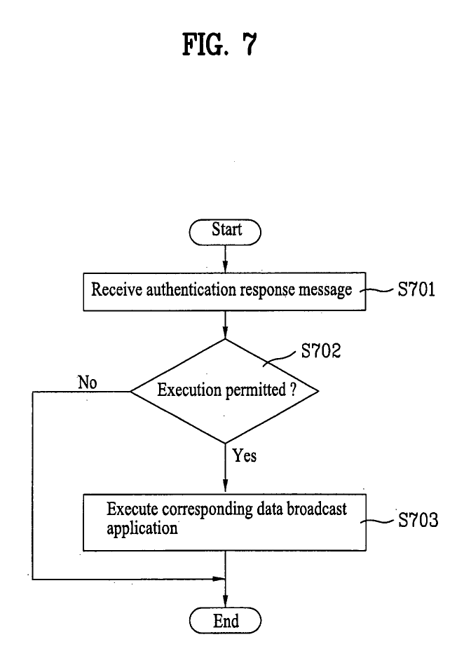

FIG. 6 is a structural diagram illustrating an authentication response message according to one embodiment of the present invention.

Referring to FIG. 6, the authentication response message may include the permission field 601 and the application identifier (ID) field 602.

1 bit is allocated to the permission field 601, so that the permission field 601 indicates whether the execution of the data broadcast application is allowed or disallowed.

For example, if the value of 1 is allocated to the permission field 601, this means that the execution of the data broadcast application is allowed. Otherwise, if the value of 0 is allocated to the permission field 601, this means that the execution of the data broadcast application is disallowed. If required, the allocation of the above values of 1 and 0 may be performed in either order.

The application identifier (ID) field 602 includes the “organization_id” field of 32 bits and the “application_id” field of 16 bits. The application ID field 602 describes a unique identifier for identifying the data broadcast application authenticated by the authentication server.

The authentication or non-authentication of the data broadcast application may be differently decided according to categories of data broadcast applications. So, if the authentication response message includes an application identifier field used as an object to be authenticated, the data broadcast applications can be easily identified from each other.

FIG. 7 is a flow chart illustrating a method for processing a data broadcast application when an authentication response message of FIG. 6 is received.

Referring to FIG. 7, upon receiving the authentication response message at step S701, the data broadcast receiving apparatus (or broadcast receiver) according to the present invention performs parsing of the permission field 601 contained in the received authentication response message, and determines whether the execution is permitted or not at step 702.

For example, if the value of 1 is allocated to the permission field 601, this means that the execution of the data broadcast application indicated by the next application identifier field 602 is permitted. If the value of 0 is allocated to the permission field 602, this means that the execution of the data broadcast application indicated by the next application ID field 602 is rejected.

If it is determined that the execution is permitted at step S702, the receiving apparatus executes the corresponding data broadcast application at step 703. Otherwise, if it is determined that the execution is not permitted at step S702, the receiving apparatus does not execute the corresponding data broadcast application.

In this case, the authentication procedure of the above-mentioned data broadcast application may be performed whenever the execution request is received. If the execution is permitted by authenticating the data broadcast application once, then the apparatus may directly execute the corresponding data broadcast application without performing the authentication procedure.

In another embodiment, the present invention may include information indicating the execution permission time in the authentication response message. In other words, the corresponding data broadcast application is limited in time, and is then authenticated.

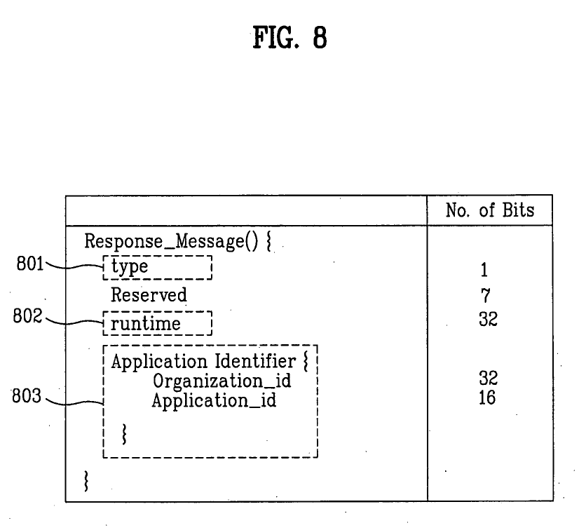

FIG. 8 is a structural diagram illustrating an authentication response message according to another embodiment of the present invention.

Referring to FIG. 8, the authentication response message includes a type field 801, a runtime field 802 indicating the execution permission time, and an application identifier (ID) field 803 for identifying the data broadcast application.

The present invention may indicate an absolute time when the runtime is indicated on the runtime field 802, or may indicate the executable time. The runtime field 802 may indicate the time value, and may be represented by the time indication scheme such as a GPS. 32 bits may be allocated to the runtime field 802.

The type field 801 may indicate whether time information marked on the runtime field 802 is an absolute time or an executable time.

For this purpose, 1 bit is allocated to the type field 801. If the value of 1 is allocated to the type field 801, the time information marked on the runtime field 802 may be set to an absolute time. Otherwise, if the value of 0 is allocated to the type field 801, the time information marked on the runtime field 802 may be set to an executable time. If required, the order of the above values 1 and 0 may be performed in either order.

In other words, the absolute time indicates an available time until a current time reaches the specific time. The executable time indicates an operable time of the data broadcast application.

For example, if the runtime field 802 has a specific value indicating 6 o'clock, this means that the absolute time continues to 6 o'clock and the executable time is 6 hours. In other words, the absolute time indicates the time or hour, and the executable time is irrelevant to the time or hour.

The application identifier field 803 includes the “organization_id” field of 32 bits and the “application_id” field of 16 bits. The application ID field 803 describes a unique identifier capable of identifying the data broadcast application authenticated by the authentication server.

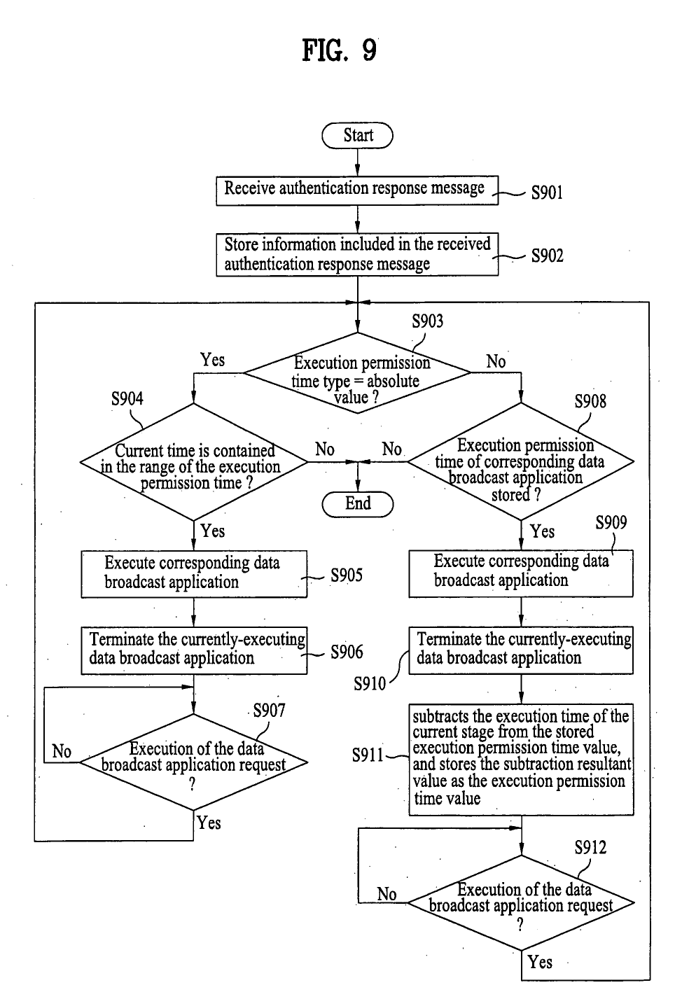

FIG. 9 is a flow chart illustrating a method for processing a data broadcast application based on an authentication response message of FIG. 8 according to the present invention.

Referring to FIG. 9, upon receiving the authentication response message at step S901, the data broadcast receiving apparatus (or broadcast receiver) according to the present invention performs parsing of the received authentication response message, and stores information contained in the authentication response message at step S902. In other words, a type field 801, a runtime field 802, type information acquired by the parsing of the application ID field 803, execution permission time information, and application ID information are stored in the received authentication response message.

And, the receiving apparatus determines whether the value marked on the next runtime field 802 is indicative of the absolute time or the executable time by referring to the type field 801 at step S903.

If it is determined that the type information is indicative of the absolute time value at step S903, the receiving apparatus determines whether a current time is contained in the range of the execution permission time marked on the runtime field 802 at step S904.

For example, provided that the current time is 9 o'clock PM whereas it is determined that the execution permission time continues to 6 o'clock PM, this current time of 9 o'clock PM is not contained in the range of the execution permission time. Provided that the current time is 3 o'clock PM, this current time of 3 o'clock PM is contained in the range of the execution permission time.

If the current time is contained in the range of the execution permission time at step S904, the apparatus performs the corresponding data broadcast application at step S905. In this case, the corresponding data broadcast application can be recognized by the parsing of the next application identifier field 803 of the aforementioned execution time field 802.

If the current time is not contained in the range of the execution permission time at step S904, the apparatus may execute the corresponding data broadcast application or may re-perform the authentication process.

If the current time exceeds the range of the execution permission time while the data broadcast application is executed, the apparatus may terminate the currently-executing data broadcast application or may re-perform the authentication process.

For example, provided that the execution permission time continues to 6 o'clock PM and a current time reaches 6 o'clock PM, the receiving apparatus may terminate the currently-executing data broadcast application. Otherwise, this data broadcast application may also be terminated by a user.

If the data broadcast application is terminated at step S906 and then the user re-requests the execution of the data broadcast application at step S907, the receiving apparatus goes to step S903, and repeats the above-mentioned steps. Otherwise, the authentication process of the data broadcast application may be performed again.

In the meantime, if the type information is decided as the executable time value at step S903, the apparatus determines whether the execution permission time of the corresponding data broadcast application is stored or not at step S908.

If the execution permission time is stored at step S908, the corresponding data broadcast application is executed at step S909.

For example, if the stored execution permission time is 0 or less, this means that the execution permission time is not stored. If it is determined that the execution permission time is not stored at step S908, the apparatus may not perform the corresponding data broadcast application, or may re-perform the authentication process.

If the pre-executed time exceeds the execution permission time while the data broadcast application is executed, the apparatus may terminate the currently-executing data broadcast application or may re-perform the authentication process.

For example, provided that the execution permission time is set to 6 hours, and the pre-executed time for the data broadcast application exceeds 6 hours, the apparatus may terminate the currently-executing data broadcast application or may terminate the user-executed data broadcast application.

If the currently-executing data broadcast application is terminated due to the above-mentioned reasons at step S910, the apparatus subtracts the execution time of the current stage from the stored execution permission time value, and stores the subtraction resultant value as the execution permission time value at step S911. In other words, the apparatus updates the stored execution permission time value.

Thereafter, if the user re-requests the execution of the data broadcast application at step S912, the apparatus goes to step S903, and repeats the above steps. Otherwise, the apparatus may re-perform the authentication process of the data broadcast application.

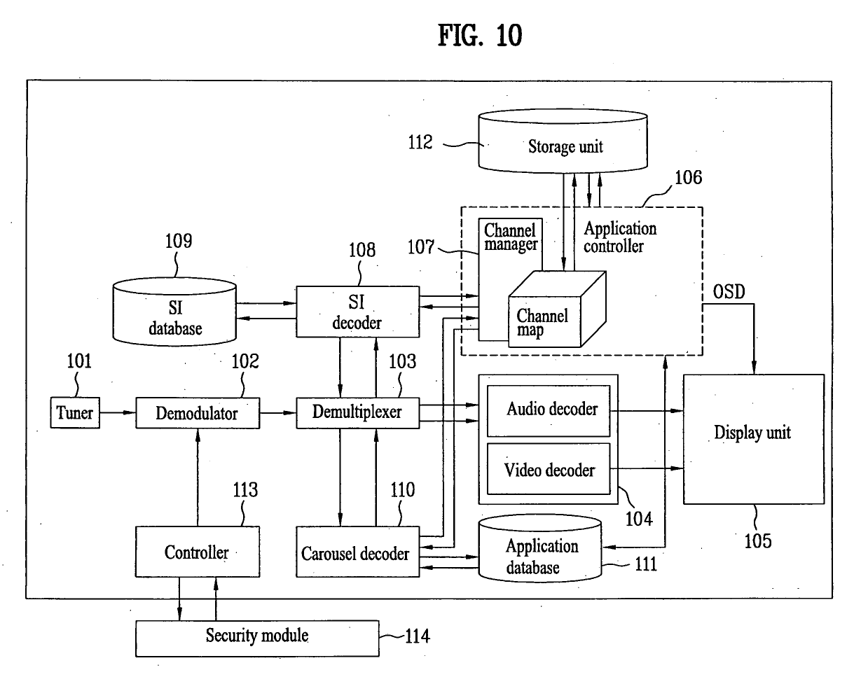

FIG. 10 is a block diagram illustrating a receiving apparatus (or receiver) for receiving a data broadcast signal according to the present invention.

Referring to FIG. 10, the data broadcast receiver according to the present invention includes a tuner 101, a demodulator 102, a demultiplexer 103, an audio/video (A/V) decoder 104, a display unit 105, an application controller 106, a system information (SI) decoder 108, a system information (SI) database 109, a carousel decoder 110, an application database 111, a storage unit 112, a controller 113. And, a security module 114 may also be connected to an external part of the data broadcast receiver. The application controller 106 may include a channel manager. The storage unit 112 can be used a NVRAM or flash memory.

For example, the data broadcast receiver may be a digital television receiver. The digital television receiver may receive not only an A/V broadcast signal but also authentication indication information contained in the application information table (AIT), and may then process the A/V broadcast signal and the authentication indication information. And, the data broadcast receiver may authenticate or execute the corresponding data broadcast application according to the concept contained in the authentication indication information.

The tuner 101 receives the data broadcast signal which includes the application information table (AIT) and the data broadcast application. This tuner 101 corresponds to the receiver.

In other words, the tuner 101 may receive a terrestrial- or cable-broadcast signal by performing the frequency tuning of a specific channel, and the received broadcast signal may be transmitted to the demodulator 102.

In this case, the tuner 101 may receive a control signal from the channel manager 107, or may inform the channel manager 107 of the result and strength of the received signal acquired by the control signal. The broadcast signal may include not only the A/V broadcast signal but also the data broadcast signal.

The demodulator 102 demodulates the tuned broadcast signal generated from the tuner 101, and transmits the demodulated result to the demultiplexer 103. The output signal demodulated by the demodulator 102 is configured in the form of a transport stream.

In this case, the terrestrial broadcast signal and the cable broadcast signal have different transmission schemes, and the demodulator 102 according to the present invention may also perform a variety of demodulation processes of signals based on different demodulation schemes.

For example, the terrestrial broadcast signal may be demodulated by the 8VSB (8 Vestigial Sideband Modulation) scheme. The cable broadcast signal may be demodulated by any one of 64 QAM, 256 QAM, and 16VSB schemes. The demodulation scope of the present invention is not limited to only the above-mentioned examples, and can also be applied to other examples.

The demultiplexer 103 may demultiplex a transport stream demodulated by the demodulator 102. In other words, the demultiplexer 103 receives the transport stream from the demodulator 102, and may filter audio data, video data, and other data associated with the data broadcasting. The demultiplexer 103 transmits the filtered audio/video data to the A/V decoder 104, and transmits data for the data broadcasting to the carousel decoder 110.

In this case, the demultiplexer 103 receives a control signal from the SI decoder 108 and/or the carousel decoder 110, and may demultiplex the received transport stream using the control signal.

The demultiplexer 103 may demultiplex the received transport stream upon receiving a control signal from the channel manager 107. In other words, if the A/V PID (Packet Identifier) of a corresponding virtual channel is set, the demultiplexer 103 transmits only the A/V elementary stream to the A/V decoder 104.

The A/V decoder 104 receives the A/V elementary stream from the demultiplexer 103, and decodes the received A/V elementary stream according to the MPEG-2 or AC3 scheme.

The A/V data decoded by the A/V decoder 104 is displayed on the display 105. For example, if the A/V data decoded by the A/V decoder 104 is video data, the display 105 displays the video data on the screen. If the A/V data decoded by the A/V decoder 104 is audio data, the display 105 outputs the audio data via a speaker. The display 150 may receive a control signal of OSD (On Screen Display) graphic data when the video data is displayed on the screen.

Upon receiving tables, including audio information, video information, and other information associated with the data broadcasting, from the transport stream, the demultiplexer 103 may demultiplex the received tables, and may then transmit the demultiplexed tables to the SI (System Information) decoder 108.

In this case, the demultiplexer 103 examines the header part commonly contained in the individual tables, so that it may demultiplex the individual tables. The tables may be PSI/PSIP tables for the A/V broadcast service, or may be application information tables for the data broadcast service.

The channel manager 107 contained in the application controller 106 manages the channel map, and controls the tuner 101 and the SI decoder 108, so that it may answer the user's channel request.

The channel manager 107 requests the parsing of the channel-associated table from the SI decoder 108, receives the parsing result, and updates the channel map. And, the channel manager 107 establishes the A/V PID acquired by the parsing of the channel-associated table in the demultiplexer 103, and may then request the demultiplexing of data.

The SI decoder 108 is used as a SI control module for parsing the PSI/PSIP-associated table section generated from the demultiplexer 103, and may perform the slave operation upon receiving a control signal from the channel manager 107.

In other words, the SI decoder 108 may control the demultiplexer 103 to perform parsing of the PSI/PSIP-associated table section contained in the broadcast signal. And, the SI decoder 108 may store the parsing-resultant information in the SI database 109. In this case, the SI decoder 108 performs parsing of the non-filtering part or the remaining actual section data of the non-filtered part from the demultiplexer 103, namely, the decoder 108 reads all of data from the non-filtering part or the remaining actual section data from the demultiplexer 103, so that the read information may be stored in the SI database 109.

The SI decoder 108 may control the demultiplexer 103 to perform parsing of the application information table (AIT) contained in the broadcast signal. The SI decoder 108 outputs the parsing result of the application information table (AIT) to the application controller 106. The SI decoder 108 may store the parsing result of the application information table (AIT) in the application database 111 or the storage unit 112, or may monitor the presence or absence of update information.

If the update situation occurs, the SI decoder 108 re-analyzes the corresponding part to be updated, so that the information stored in the application database 111 can be always updated with new information.

The carousel decoder 110 receives the data broadcast—associated stream from the demultiplexer 103, decodes the received stream (e.g., the data broadcast application), and stores the decoded result in the application database 111 or outputs the decoded result to the application controller 106. Also, upon receiving a control signal from the channel manager 107, the carousel decoder 110 may perform the slave operation in the same manner as in the SI decoder 108.

The application controller 106 may detect the charging descriptor of FIG. 3 from the application information table (AIT) parsed by the SI decoder 108, and may extract the authentication server information from the charging descriptor.

In other words, if the application controller 106 receives the data broadcast application execution request from the platform, and detects the charging descriptor associated with the data broadcast application from the application information table (AIT), the application controller 106 generates the authentication request message of FIG. 5 on the basis of the authentication server information contained in the charging descriptor, and transmits the authentication request message to the corresponding authentication server.

The application controller 106 receives the authentication response message including the authentication result caused by the authentication request from the authentication server. If the execution is permitted by the received authentication response message, the application controller 106 performs the corresponding data broadcast application. The authentication response message may include first information indicating whether the execution is permitted as shown in FIG. 6, or may also include second information indicating the runtime information. The above-mentioned explanation is equally applied to not only the authentication process but also the execution process.

And, the application controller 106 may control the display 105 using the OSD graphic data. In other words, the application controller 106 manages the application status and the database, and may manage or control the OSD associated with the data broadcasting. Also, the application controller 106 controls the channel manager 107, so that it may perform the channel-associated operations (e.g., the channel map management or the SI decoder management). The GUI control of the broadcast receiver, the user request, and the status of the broadcast receiver may be stored in the storage unit 112, or may be recovered.

In the meantime, the broadcast receiver may also be associated with the demodulation of the broadcast signal received via the security module 114 connected to an external part. For example, if the scramble is loaded on the demodulated broadcast signal, the security module 114 may descramble the scrambled broadcast signal, and may output the descrambled result to the demultiplexer 103. For this operation, the security module 114 may include a conditional access system (CAS).

For example, if the broadcast receiver is able to receive the cable broadcast signal, the security module 114 may be set to the cable card. For another example, if the broadcast receiver is able to receive the satellite broadcast signal, the security module 114 may be set to the smart card. The security module 114 may be detachably connected to the broadcast receiver.

The security module 114 according to the present invention includes the CAS, and is detachably connected to the broadcast receiver. In this case, the broadcast signal generated from the broadcast station may be descrambled by the CAS of the security module 114, and the descrambled result is provided to users.

However, according to yet another embodiment, the present invention downloads the software CAS of the broadcast station in the broadcast receiver, so that it may perform the conventional CAS function. In other words, the software CAS downloaded from the broadcast station may be stored in a predetermined memory of the broadcast receiver. However, the above-mentioned example has been disclosed only for illustrative purposes, and the difference in the above-mentioned embodiments may not affect or modify the scope of the present invention, so that various modifications and variations can be made in the present invention without departing from the spirit or scope of the invention.

As apparent from the above description, the apparatus and method for processing the data broadcast signal according to the present invention is designed to authenticate the data broadcast application, so that it can provide users with the high-class data broadcast service. The present invention authenticates the individual data broadcast applications independent of each other, so that the authentication process can be more effectively conducted, resulting in the occurrence of more detailed authentication processes.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for receiving and processing a data broadcast signal comprising:
receiving a data broadcast signal including an application information table and an application;
authenticating the application; and
executing the application only when an execution is permitted according to the authentication result.

2. The method according to claim 1, wherein the authenticating step includes:
detecting authentication indication information including location information of an authentication server from the application information table;
generating an authentication request message of a corresponding application, and transmitting the authentication request message to the authentication server, when the authentication indication information is detected; and
receiving an authentication response message associated with the authentication-requested application from the authentication server.

3. The method according to claim 2, wherein the authentication indication information is contained in a common loop in the application information table.

4. The method according to claim 2, wherein the authentication indication information is contained in an application loop in the application information table.

5. The method according to claim 2, wherein the authentication indication information is configured in the form of a field, and is then contained in the application information table.

6. The method according to claim 2, wherein the authentication indication information is configured in the form of a descriptor, and is then contained in the application information table.

7. The method according to claim 2, wherein the authentication request message includes:
first identification information for identifying a receiver generating an authentication request; and
second identification information for identifying an application generating an authentication request.

8. The method according to claim 2, wherein the authentication response message includes specific information indicating whether the execution is permitted.

9. The method according to claim 2, wherein the authentication response message includes runtime information for limiting a runtime of a corresponding application.

10. The method according to claim 9, wherein the runtime information may include at least one of an absolute time value and an executable time value, and the authentication response message further includes discrimination information for discriminating between the absolute time value and the executable time value.

11. The method according to claim 2, wherein the authentication response message further includes identification information for identifying the authenticated application.

12. An apparatus for receiving and processing a data broadcast signal comprising:
a receiving unit for receiving a data broadcast signal including an application information table and an application;
a decoder for decoding the received application and the received application information table; and
an application controller for controlling authentication of the application according to information contained in the decoded application information table, and controlling execution of the application according to the authentication result.

13. The apparatus according to claim 12, wherein the application controller, if authentication indication information including location information of an authentication server is detected from the application information table, generates an authentication request message of a corresponding application, transmits the authentication request message to the authentication server, and receives an authentication response message associated with the authentication-requested application from the authentication server.

14. The apparatus according to claim 13, wherein the application controller executes the corresponding application only when the execution is permitted by the authentication response message.

15. The apparatus according to claim 13, wherein the authentication indication information is contained in at least one of common and application loops in the application information table.

16. The apparatus according to claim 13, wherein the authentication indication information is configured in the form of a descriptor, and is then contained in the application information table.

17. The apparatus according to claim 13, wherein the authentication request message includes:
first identification information for identifying a receiver generating an authentication request; and
second identification information for identifying an application generating an authentication request.

18. The apparatus according to claim 13, wherein the authentication response message includes specific information indicating whether the execution is permitted.

19. The apparatus according to claim 13, wherein the authentication response message includes runtime information for limiting a runtime of a corresponding application.

20. The apparatus according to claim 19, wherein the runtime information may include at least one of an absolute time value and an executable time value, and the authentication response message further includes discrimination information for discriminating between the absolute time value and the executable time value.
